(19) United States
(12) Patent Application Publication
(10) Pub. No.: US 2023/0245179 A1
(43) Pub. Date: Aug. 3, 2023

(54) INFORMATION PROCESSING APPARATUS, INFORMATION PROCESSING METHOD, AND PROGRAM

(71) Applicant: SONY GROUP CORPORATION, TOKYO (JP)

(72) Inventors: SHIN TAKANASHI, TOKYO (JP); MASAO ERIGUCHI, TOKYO (JP)

(21) Appl. No.: 18/002,658

(22) PCT Filed: Jun. 16, 2021
(86) PCT No.: PCT/JP2021/022850

§ 371 Date: Dec. 20, 2022

(30) Foreign Application Priority Data
Jun. 30, 2020 (JP) 2020-113181

(51) Int. Cl. G06Q 30/0241; G06Q 30/0251

(52) U.S. Cl. CPC G06Q 30/0276; G06Q 30/0265

(57) ABSTRACT

An information processing apparatus according to an embodiment of the present technology includes a plan creation section. The plan creation section creates a plan of movement of a mobile object to a destination of the mobile object in association with advertisement effectiveness on the basis of the destination and a desired time of arrival at the destination, the advertisement effectiveness being provided by advertisement content played back outward from the mobile object. This makes it possible to create the movement plan enabling the advertisement vehicle to arrive at the destination by the desired arrival time, and achieving a highest degree of the advertisement effectiveness. This results in being able to achieve a high degree of advertisement effectiveness in advertisement using the mobile object.

### TECHNICAL FIELD

The present technology relates to an information processing apparatus, an information processing method, and a program that can be applied to advertisement using a mobile object.

### BACKGROUND ART

Patent Literature 1 discloses a mobile-object advertisement system used to match an owner of a mobile object that is an advertising medium and an advertiser who wants to perform advertisement using a mobile object. In the mobile-object advertisement system, a display permission condition specified by an owner of a mobile object is matched to a display condition specified by a content provider. This results in digital signage using a mobile object (for example, paragraphs [0010], [0014], and [0016] in the specification of Patent Literature 1).

### CITATION LIST

### Patent Literature

Patent Literature 1: Japanese Patent Application Laid-open No. 2018-092385

### DISCLOSURE OF INVENTION

### Technical Problem

There is a need for a technology that makes it possible to achieve a high degree of advertisement effectiveness in advertisement using a mobile object.

In view of the circumstances described above, it is an object of the present technology to provide an information processing apparatus, an information processing method, and a program that make it possible to achieve a high degree of advertisement effectiveness in advertisement using a mobile object.

### Solution to Problem

In order to achieve the object described above, an information processing apparatus according to an embodiment of the present technology includes a plan creation section.

The plan creation section creates a plan of movement of a mobile object to a destination of the mobile object in association with advertisement effectiveness on the basis of the destination and a desired time of arrival at the destination, the advertisement effectiveness being provided by advertisement content played back outward from the mobile object.

In the information processing apparatus, a movement plan of the mobile object is created in association with advertisement effectiveness on the basis of a destination and a desired arrival time. This makes it possible to achieve a high degree of advertisement effectiveness in advertisement using a mobile object.

The plan creation section may create the movement plan enabling the mobile object to arrive at the destination by the desired arrival time, and achieving a highest degree of the advertisement effectiveness.

The plan creation section may calculate a plurality of candidate routes to the destination, may estimate the advertisement effectiveness for each of the plurality of candidate routes, and may create the movement plan on the basis of the estimated advertisement effectiveness.

The plan creation section may create the movement plan such that the mobile object moves along a maximum effectiveness route, from among the plurality of candidate routes, that achieves a highest degree of the advertisement effectiveness.

The information processing apparatus may further include an information acquisition section that is capable of acquiring estimated viewer information regarding an estimated viewer estimated to view the advertisement content. In this case, the plan creation section may estimate the advertisement effectiveness on the basis of the acquired estimated viewer information.

The estimated viewer information may include at least one of the number of the estimated viewers, an age of the estimated viewer, a gender of the estimated viewer, or a stay time of the estimated viewer.

The estimated viewer information may include at least one of pedestrian information regarding a pedestrian or information regarding a degree of density of people.

The mobile object may be a vehicle. In this case, the information acquisition section may be capable of acquiring surrounding environment information that includes at least one of traffic volume, traffic laws, weather, or a period of time. Further, the plan creation section may estimate the advertisement effectiveness on the basis of the acquired surrounding environment information.

The movement plan may include at least one of a route to the destination, a movement speed, a stop location, or a stop period of time at the stop location.

The mobile object may be a vehicle. In this case, the movement plan may include at least one of a route to the destination, a traveling lane, a traveling speed, a parking location, or a parking period of time at the parking location.

The information processing apparatus may further include an information acquisition section that is capable of acquiring estimated viewer information regarding an estimated viewer estimated to view the advertisement content. In this case, the plan creation section may create the movement plan on the basis of the acquired estimated viewer information.

The information processing apparatus may further include an advertisement-target-information acquiring section that acquires advertisement target information regarding a target for an advertisement of the advertisement content. In this case, the plan creation section may create the movement plan on the basis of the acquired advertisement target information.

The information processing apparatus may further include an information acquisition section that is capable of acquiring estimated viewer information regarding an estimated viewer estimated to view the advertisement content, and an advertisement content selecting section that selects the advertisement content on the basis of the acquired estimated viewer information.

The mobile object may provide transportation services. In this case, the plan creation section may calculate a plurality of candidate routes to the destination. Further, the information processing apparatus may further include an advertising income calculator that calculates an estimated advertising income for each of the plurality of candidate routes.

The information processing apparatus may further include a fare calculator that calculates an estimated fare for each of the plurality of candidate routes, and a presentation section that presents a difference between the estimated advertising income and the estimated fare.

The advertising income calculator may be capable of calculating a real advertising income on the basis of an amount of viewing of the advertisement content.

An information processing method according to an embodiment of the present technology is an information processing method that is performed by a computer system, the information processing method including creating a plan of movement of a mobile object to a destination of the mobile object in association with advertisement effectiveness on the basis of the destination and a desired time of arrival at the destination, the advertisement effectiveness being provided by advertisement content played back outward from the mobile object.

A program causes a computer program to perform a process including creating a plan of movement of a mobile object to a destination of the mobile object in association with advertisement effectiveness on the basis of the destination and a desired time of arrival at the destination, the advertisement effectiveness being provided by advertisement content played back outward from the mobile object.

### BRIEF DESCRIPTION OF DRAWINGS

FIG. 1 is a schematic diagram used to describe a movement plan creating system according to an embodiment.

FIG. 2 schematically illustrates an example of an appearance of an advertisement vehicle.

FIG. 3 is a block diagram illustrating an example of a functional configuration of the advertisement vehicle.

FIG. 4 is a block diagram illustrating an example of a functional configuration of an information processing apparatus (a first embodiment).

FIG. 5 is a flowchart illustrating an example of creating a movement plan.

FIG. 6 is a schematic diagram used to describe the example of creating a movement plan.

FIG. 7 is a schematic diagram used to describe the example of creating a movement plan.

FIG. 8 is a schematic diagram used to describe the example of creating a movement plan.

FIG. 9 schematically illustrates another example of calculating a maximum effectiveness route.

FIG. 10 is a block diagram illustrating an example of the functional configuration of the information processing apparatus (a second embodiment).

FIG. 11 is a flowchart illustrating an example of operating transportation services.

FIG. 12 is a schematic diagram used to describe the example of operating the transportation services.

FIG. 13 is a schematic diagram used to describe creation of a movement plan using a machine learning model.

FIG. 14 is a block diagram illustrating an example of a configuration of hardware of the information processing apparatus.

### MODE(S) FOR CARRYING OUT THE INVENTION

Embodiments according to the present technology will now be described below with reference to the drawings.

[Movement Plan Creating System]

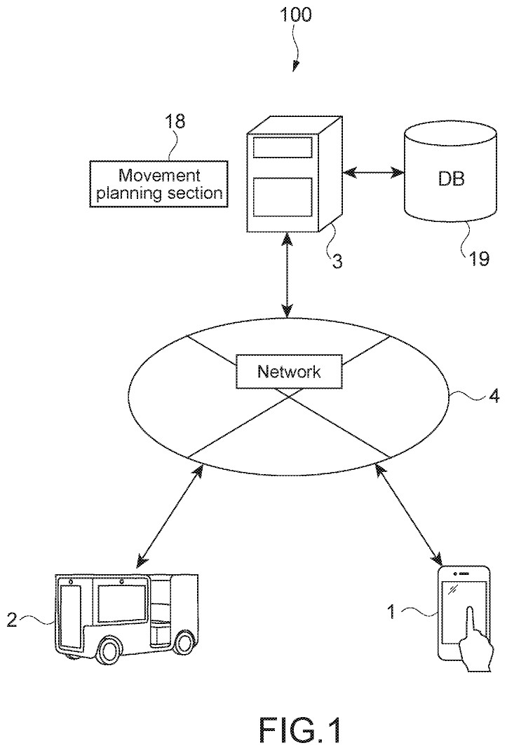

FIG. 1 is a schematic diagram used to describe a movement plan creating system according to an embodiment of the present technology.

A movement plan creating system 100 includes a user terminal 1, an advertisement vehicle 2, and an information processing apparatus 3.

The user terminal 1, the advertisement vehicle 2, and the information processing apparatus 3 are communicatively connected to each other through a network 4.

The network 4 is built by, for example, the Internet or a wide area communication network. Moreover, for example, any wide area network (WAN) or any local area network (LAN) may be used, and a protocol used to build the network 4 is not limited.

The user terminal 1 is a terminal used by a user who uses the movement plan creating system 100. Any computer such as a mobile terminal or a laptop may be used as the user terminal 1, where examples of the mobile terminal include a smartphone, a tablet terminal, and various personal digital assistants (PDAs).

In the present embodiment, various information regarding the movement plan creating system 100 is input by the user through the user terminal 1.

For example, a destination of the advertisement vehicle 2, and a desired time of arrival at the destination are input. Moreover, any information such as a departure point and a departure time may be capable of being input.

The advertisement vehicle 2 can play back advertisement content outward during traveling.

Examples of the advertisement content include an image used for advertisement (including a still image and a moving image) and sound used for advertisement.

For example, the advertisement vehicle 2 can travel while displaying an image used for advertisement. Further, the advertisement vehicle 2 can travel while outputting sound used for advertisement. Of course, the display of an image used for advertisement and the output of sound used for advertisement may be performed at the same time.

Further, in the present embodiment, the advertisement vehicle 2 includes an automated driving function. For example, a user can get on the advertisement vehicle to move to a desired destination. The automated driving function enables a user to move to a destination without driving himself/herself.

Of course, the present technology is not limited to being applied to the case in which the advertisement vehicle 2 includes an automated driving function and to the case in which a user gets on the advertisement vehicle.

In the present embodiment, the advertisement vehicle 2 corresponds to an embodiment of a mobile object.

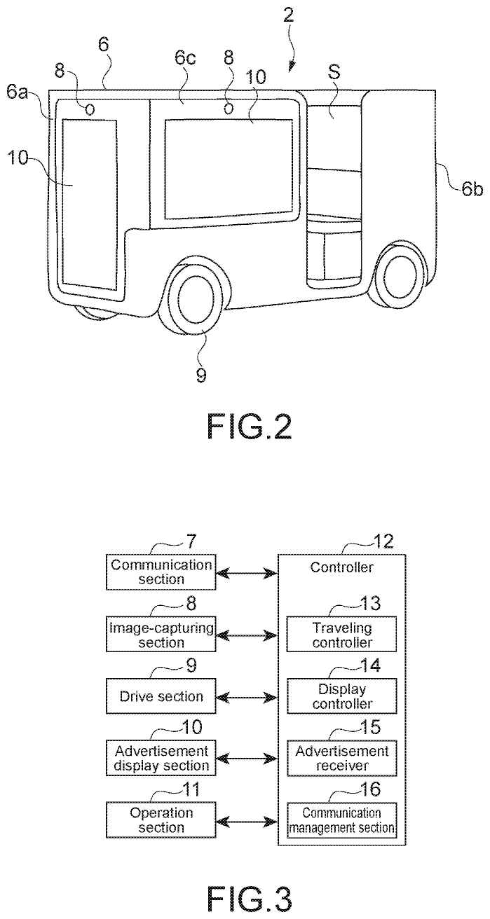

FIG. 2 schematically illustrates an example of an appearance of the advertisement vehicle.

FIG. 3 is a block diagram illustrating an example of a functional configuration of the advertisement vehicle.

As illustrated in FIG. 2, the advertisement vehicle 2 includes a vehicle body 6 in which a boarding space (an internal space) S is formed internally. The vehicle body 6 includes a front surface 6a, a rear surface 6b, a left surface 6c, and a right surface (the reference numeral is omitted). Further, the vehicle body 6 includes a top surface (the reference numeral is omitted) of which a portion can be opened and closed.

Further, as illustrated in FIGS. 2 and 3, the advertisement vehicle 2 includes a communication section 7, an image-capturing section 8, a drive section 9, an advertisement display section 10, an operation section 11, and a controller 12.

The communication section 7 is a device used to communicate with another apparatus.

For example, a wireless LAN module such as a Wi-Fi module, and a communication apparatus such as a modem and a router are used as the communication section 7. Any other communication device may be used.

The communication section 7 may be arranged at any location. In the present embodiment, various information including a movement plan created by the information processing apparatus 3 is acquired through the communication section 7.

The image-capturing section 8 is provided to the advertisement vehicle 2 to face outward. In the present embodiment, the respective image-capturing sections 8 are arranged to be oriented toward directions of the front surface 6a, the rear surface 6b, the left surface 6b, and the right surface of the advertisement vehicle 2.

An image of a region around the advertisement vehicle 2 can be captured using the image-capturing section 8.

For example, a digital camera such as a charge coupled device (CCD) camera is used as the image-capturing section 8. Further, a ranging sensor (a depth sensor) or an infrared camera may be used. Any other image-capturing device may be used.

The drive section 9 can drive the advertisement vehicle 2.

For example, apparatuses such as a tire and a brake are used as the drive section 9. Any other apparatus may be used.

The advertisement display section 10 can display, as advertisement content, an image used for advertisement outward from the advertisement vehicle 2.

In the present embodiment, the advertisement display section 10 is arranged on each of the front surface 6a, the rear surface 6b, the left surface 6c, and the right surface of the advertisement vehicle 2, as illustrated in FIG. 2.

Any display device such as a liquid crystal display or an organic electroluminescence (EL) display may be used as the advertisement display section 10.

When sound used for advertisement is played back as advertisement content, a sound reproduction device such as a speaker is provided to face outward from the advertisement vehicle 2.

The operation section 11 is a device used by a user to input various information, and is arranged in the boarding space S of the advertisement vehicle 2.

For example, a touch panel is arranged as the operation section 11. The user in the advertisement vehicle 2 operates the touch panel while confirming information displayed on the touch panel. Accordingly, the user can input various information.

Without being limited thereto, any devices such as a keyboard and a mouse may be used as the operation section 11. Further, for example, a display apparatus may be arranged.

In the present embodiment, various information regarding the movement plan creating system 100 can be input through the operation section 11.

The operation section 11 can also be used instead of the user terminal 1. In other words, for example, a destination and a desired arrival time may be input through the operation section 11.

The controller 12 includes hardware, such as a processor such as a CPU, a GPU, and a DSP; a memory such as a ROM and a RAM; and a storage device such as an HDD, that is necessary for a configuration of a computer. Of course, hardware such as an FPGA or an ASIC may be used.

In the present embodiment, a traveling controller 13, a display controller 14, an advertisement receiver 15, and a communication management section 16 are implemented as functional blocks by the CPU or the like executing a specified program. Of course, dedicated hardware such as an integrated circuit (IC) may be used in order to implement the functional blocks.

The program is installed on the advertisement vehicle 2 through, for example, various recording media. Alternatively, the installation of the program may be performed via, for example, the Internet.

The type and the like of a recording medium that records therein a program are not limited, and any computer-readable recording medium may be used. For example, any non-transitory computer-readable recording medium may be used.

The traveling controller 13 controls the drive section 9 in order to perform automated driving. In the present embodiment, automated driving is performed on the basis of a movement plan created by the information processing apparatus 3.

A specific algorithm used to perform automated driving is not limited. For example, an image of surroundings that is acquired by the image-capturing section 8 may be used. Further, for example, various machine learning algorithms may be used in order to perform automated driving.

The display controller 14 controls display of advertisement content that is performed by the advertisement display section 10.

The advertisement receiver 15 receives playback-target advertisement content through the communication section 7.

The communication management section 16 manages communication of information (data) that is performed through the communication section 7.

For example, the communication management section 16 manages a transmission-destination device and transmission details (transmission data) transmitted to the transmission-destination device. Further, the communication management section 16 manages a transmission-source device and received details (received data) received from the transmission-source device. Any other processing regarding communication may be performed.

Note that the communication management section 16 and another block may work cooperatively when the advertisement vehicle 2 and another device communicate with each other.

A configuration of the advertisement vehicle 2 is not limited, and the advertisement vehicle 2 may be designed discretionarily. Further, when the advertisement vehicle 2 travels on a highway, it is sufficient if the advertisement vehicle 2 is designed such that all of the conditions are satisfied.

An example of the present technology in which the advertisement vehicle 2 is designed such that the advertisement vehicle 2 can travel on a highway is described below. Of course, the present technology is not limited to being applied to the case in which the advertisement vehicle 2 can travel on a highway. The present technology can also be applied to the case in which the advertisement vehicle 2 travels in a private land such as a theme park.

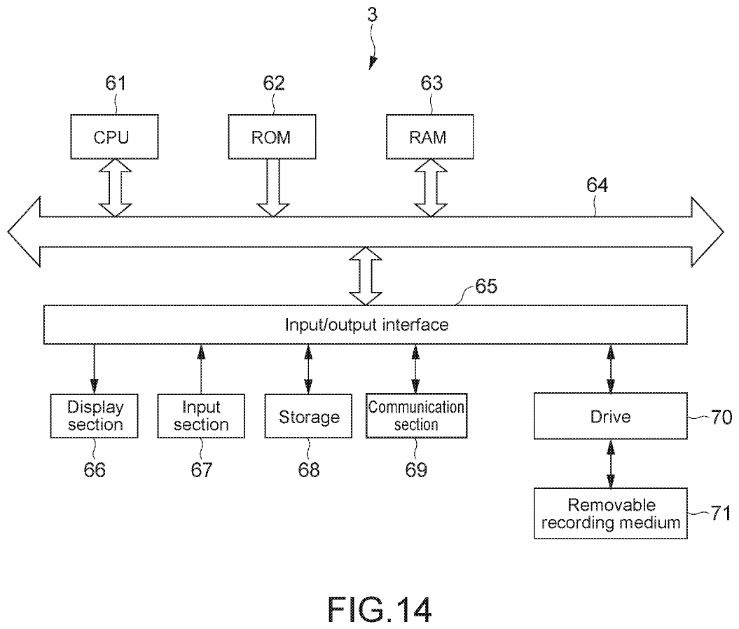

Returning to FIG. 1, the information processing apparatus 3 includes hardware, such as a processor such as a CPU, a GPU, and a DSP; a memory such as a ROM and a RAM; and a storage device such as an HDD, that is necessary for a configuration of a computer. Of course, hardware such as an FPGA or an ASIC may be used (refer to FIG. 14).

For example, an information processing method according to the present technology is performed by, for example, the CPU loading, into the RAM, a program according to the present technology that is recorded in, for example, the ROM in advance and executing the program.

The program is installed on the information processing apparatus 3 through, for example, various recording media. Alternatively, the installation of the program may be performed via, for example, the Internet.

The type and the like of a recording medium that records therein a program are not limited, and any computer-readable recording medium may be used. For example, any non-transitory computer-readable recording medium may be used.

For example, the information processing apparatus 3 can be implemented by any computer such as a PC.

In the present embodiment, a plan creation section 18 is implemented as a functional block by the CPU or the like executing a specified program. Of course, dedicated hardware such as an integrated circuit (IC) may be used in order to implement the functional block.

The plan creation section 18 creates a plan of movement of a mobile object to a destination of the mobile object in association with advertisement effectiveness on the basis of the destination and a desired time of arrival at the destination, the advertisement effectiveness being provided by advertisement content played back outward from the mobile object.

In the present embodiment, a plan of movement of the advertisement vehicle 2 to a destination of the advertisement vehicle 2 is created in association with advertisement effectiveness on the basis of the destination and a desired time of arrival at the destination, the advertisement effectiveness being provided by advertisement content played back outward from the advertisement vehicle 2.

The movement plan includes any information regarding how a mobile object moves to a destination.

Examples of the movement plan include a route to a destination, a movement speed, a stop location, and a stop period of time at the stop location. One of these parameters may be created as a movement plan. For example, the route may be determined in advance, and how fast the mobile object moves on the route may be created as a movement plan.

When a route to a destination is created as a movement plan, not only a shortest route but also any route may be created. For example, any route such as a route of intentionally taking time to go a long way, a route of stopping at a location for a specified period of time on the way, or a route of going around one route multiple times on the way may be created.

In the present embodiment, the advertisement vehicle 2 is used as a mobile object.

Thus, the movement plan includes any information regarding how the advertisement vehicle 2 travels to a destination.

Examples of the movement plan include a route to a destination, a traveling lane, a traveling speed, a parking location, and a parking period of time at the parking location. One of these parameters may be created as a movement plan.

When a route to a destination is created as a movement plan, not only a shortest route but also any route may be created. For example, any route such as a route of intentionally going through a road congested due to large volumes of traffic, a route of parking for a specified period of time in an area crowded with people, or a route of going around the area crowded with people multiple times may be created.

Creating a movement plan in association with advertisement effectiveness includes, for example, calculating a movement plan in association with advertisement effectiveness estimated when a mobile object moves on the basis of the movement plan.

The creating a movement plan in association with advertisement effectiveness includes, for example, creating a movement plan with which a degree of advertisement effectiveness is estimated to be relatively high, creating a movement plan with which a degree of advertisement effectiveness is estimated to be relatively moderate, and creating a movement plan with which a degree of advertisement effectiveness is estimated to be relatively low.

Further, the creating a movement plan in association with advertisement effectiveness also includes the case in which an estimation value of advertisement effectiveness is calculated using, for example, a numerical value and a movement plan is created with the estimation value.

Note that, for example, the advertisement effectiveness can be estimated on the basis of any parameter with which advertisement effectiveness can be determined.

Examples of the parameter with which advertisement effectiveness can be determined include any parameters that may have an impact on to what extent advertisement content is viewed (an amount of viewing of advertisement content).

For example, any parameters, such as the number of people on a route on which a mobile object moves, an amount of movement of another mobile object, information regarding a degree of density of people, weather, a period of time, and details of advertisement content, that have an impact on an amount of viewing the advertisement content.

Furthermore, for example, the creating a movement plan in association with advertisement effectiveness includes creating a movement plan on the basis of any parameter with which advertisement effectiveness can be determined. For example, the creating a movement plan in association with advertisement effectiveness also includes creating a movement plan on the basis of these parameters without estimating advertisement effectiveness.

It is assumed that, for example, a movement plan for moving in a densely populated region, or a movement plan for moving during heavy pedestrian traffic hours is created without estimating advertisement effectiveness. Such a creation of a movement plan is also included in the creating a movement plan in association with advertisement effectiveness.

In the present embodiment, the plan creation section 18 can create a movement plan that enables a mobile object to arrive at a destination by a desired arrival time, and that achieves a highest degree of advertisement effectiveness.

In other words, the plan creation section 18 can create a movement plan that enables the advertisement vehicle 2 to arrive at a destination by a desired arrival time, and that achieves a highest degree of advertisement effectiveness.

In the example illustrated in FIG. 1, the information processing apparatus 3 includes a database (DB) 19. The DB 19 may be constructed by a storage device included in the information processing apparatus 3. Alternatively, the DB 19 may be constructed in an external storage device. In this case, the information processing apparatus 3 and the external storage device serve as an embodiment of an information processing apparatus according to the present technology.

The DB 19 stores therein various information regarding the movement plan creating system 100.

For example, any information such as map information; any information regarding advertisement content; and information regarding, for example, traffic volume, traffic laws (for example, a speed limit and parking ban), and weather may be stored.

Further, a movement plan created in the past and various information used to create a movement plan in the past may be stored as history information.

Furthermore, for example, statistically calculated population and population density for each region, and statistically calculated population and population density on a principal road may be stored.

### First Embodiment

A first embodiment of the information processing apparatus 3 illustrated in FIG. 1 is described in detail.

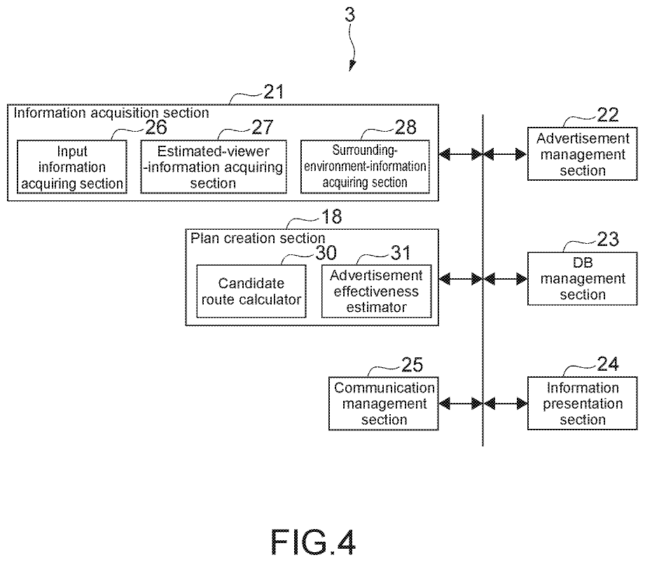

FIG. 4 is a block diagram illustrating an example of a functional configuration of the information processing apparatus 3 according to the present embodiment.

The information processing apparatus 3 includes an information acquisition section 21, the plan creation section 18, an advertisement management section 22, a DB management section 23, an information presentation section 24, and a communication management section 25.

These functional blocks are implemented by, for example, a processor executing a specified program. Of course, dedicated hardware such as an integrated circuit (IC) may be used in order to implement the functional blocks.

The information acquisition section 21 acquires various information regarding the movement plan creating system 100.

For example, the information acquisition section 21 can acquire, for example, a current time, position information regarding a position of the user terminal 1 (a current location of a user), and position information regarding a position of the advertisement vehicle 2 (a current location of the advertisement vehicle 2). For example, the position information can be acquired on the basis of, for example, GPS information.

Further, in the present embodiment, the information acquisition section 21 includes an input information acquiring section 26, an estimated-viewer-information acquiring section 27, and a surrounding-environment-information acquiring section 28.

The input information acquiring section 26 acquires input information that is input by a user through the user terminal 1.

Examples of the input information include a destination of the advertisement vehicle 2 and a desired time of arrival at the destination. Moreover, various information such as a departure time and a desired way-stop may be acquired.

The estimated-viewer-information acquiring section 27 includes any information regarding an estimated viewer estimated to view advertisement content.

For example, examples of the estimated viewer information include the number of estimated viewers, an age of an estimated viewer, a gender of an estimated viewer, and a stay time of an estimated viewer.

Examples of the estimated viewer include a pedestrian, staff of a store, a person in another vehicle, and a transportation user. Thus, pedestrian information regarding a pedestrian may be acquired as the estimated viewer information. For example, the number of pedestrians on a route, an age of a pedestrian, a gender of a pedestrian, or a stay time of an estimated viewer may be acquired as the estimated viewer information.

Further, for example, information regarding a degree of density of people may be acquired as the estimated viewer information. The information regarding a degree of density includes not only information regarding a degree of density for each region, but also information regarding a region with a high degree of density. For example, the information regarding a degree of density also includes information regarding downtowns such as Shibuya, Shinjuku, and Ikebukuro. For example, information regarding a date and time/a period of time with a high degree of density, such as “a certain region in a certain period of time”, may be used as the information regarding a degree of density.

For example, the estimated viewer information can be acquired on the basis of various information published through a network. For example, the estimated viewer information is acquired on the basis of, for example, density information, GPS information, and base station information. Of course without being limited thereto, the estimated viewer information may be acquired on the basis of, for example, image-capturing information obtained by image-capturing being performed by a surveillance camera arranged for each area.

Further, current estimated viewer information may be estimated on the basis of, for example, history information stored in the DB 19. Such a case is also included in the acquisition of estimated viewer information.

The surrounding-environment-information acquiring section 28 acquires surrounding environment information.

Examples of the surrounding environment information include traffic volume, traffic laws, weather, and a period of time. Of course without being limited thereto, any information regarding the surrounding environment is included.

For example, the surrounding environment information can be acquired on the basis of various information published through a network. For example, the surrounding environment information is acquired on the basis of, for example, traffic jam information and weather information. Of course without being limited thereto, the surrounding environment information may be acquired on the basis of, for example, image-capturing information obtained by image-capturing being performed by a surveillance camera arranged for each area.

Further, current surrounding environment information may be estimated on the basis of, for example, history information stored in the DB 19. Such a case is also included in the acquisition of surrounding environment information.

Note that the estimated viewer information and the surrounding environment information can be used as the parameters with which advertisement effectiveness can be determined.

In the present embodiment, the plan creation section 18 includes a candidate route calculator 30 and an advertisement effectiveness estimator 31.

The candidate route calculator 30 calculates a plurality of candidate routes to a destination.

For example, a candidate route that makes it possible to arrive at a destination by a desired arrival time is calculated on the basis of map information stored in the DB 19. Moreover, any algorithm may be used in order to calculate a candidate route.

The advertisement effectiveness estimator 31 estimates advertisement effectiveness for each of the plurality of candidate routes.

In the present embodiment, the advertisement effectiveness is estimated on the basis of the estimated viewer information and surrounding environment information described above. Both the estimated viewer information and the surrounding environment information may be used, or one of them may be used. Further, one of the pieces of estimated viewer information described above may be used. Furthermore, one of the pieces of surrounding environment information described above may be used.

For example, the number of estimated viewers or a degree of density of people may be used as a result of estimating advertisement effectiveness with no change. In other words, a degree of advertisement effectiveness is estimated to be high on a candidate route with a large number of estimated viewers. Further, a degree of advertisement effectiveness is estimated to be high on a candidate route that passes through an area with a high degree of density of people.

Furthermore, the advertisement effectiveness may be estimated using an expression indicated below.

Result of estimating advertisement effectiveness=number of estimated viewers×number of times that advertisement is played back

Further, the advertisement effectiveness may be estimated using an expression indicated below.

Result of estimating advertisement effectiveness=number of estimated viewers×number of times that advertisement is played back×weighting coefficient

Here, the weighting coefficient is a parameter that is calculated according to advertisement content. For example, when the advertisement content is advertisement content regarding luxury-brand cosmetics, a higher weighting coefficient is set for a candidate route on which there is a larger number of women as estimated viewers.

Moreover, any algorithm may be adopted as a method for estimating advertisement effectiveness. For example, a degree of advertisement effectiveness is estimated to be high when a large number of parameters corresponding to factors in increasing advertisement effectiveness is included.

The advertisement management section 22 manages playback-target advertisement content.

For example, the advertisement management section 22 receives advertisement content from an advertiser (or an advertising agency) and stores therein the received advertisement content. Further, the advertisement management section 22 manages advertisement content information regarding advertisement content.

Examples of the advertisement content information include information regarding, for example, an advertiser, an advertising agency, and an advertising period. Further, examples of the advertisement content information include advertisement target information regarding a target for an advertisement of advertisement content. For example, an age group, a gender, and a residential area of a target for an advertisement are acquired and managed as the advertisement target information.

Further, the advertisement management section 22 can select advertisement content to be played back by the advertisement vehicle 2, and transmit the selected advertisement content to the advertisement vehicle 2.

The advertisement management section 22 serves as an embodiment of an advertisement-target-information acquiring section according to the present technology. Further, the advertisement management section 22 serves as an embodiment of an advertisement content selecting section according to the present technology.

The DB management section 23 manages information stored in the DB 19. Further, the DB management section 23 writes data into the DB 19 and reads data from the DB 19.

The information presentation section 24 generates information to be presented to a user, and transmits the generated information to the user terminal 1 and the advertisement vehicle 2. For example, a graphical user interface (GUI) used to input information is generated and transmitted to the user terminal 1 and the advertisement vehicle 2. Moreover, various information such as notification information regarding the movement plan creating system 100 may be generated and transmitted to, for example, the user terminal 1.

Further, for example, sound data used for notification may be generated and transmitted to, for example, the user terminal 1.

The information presentation section 24 corresponds to an embodiment of a presentation section according to the present technology.

The communication management section 25 manages communication of information (data) that is performed through the communication section 69 (refer to FIG. 14).

For example, the communication management section 25 manages a transmission-destination device and transmission details (transmission data) to be transmitted to the transmission-destination device. Further, the communication management section 25 manages a transmission-source device and received details (received data) received from the transmission-source device. Any other processing regarding communication may be performed.

Note that the communication management section 25 and another block may work cooperatively when the information processing apparatus 3 and another device communicate with each other.

[Creation of Movement Plan]

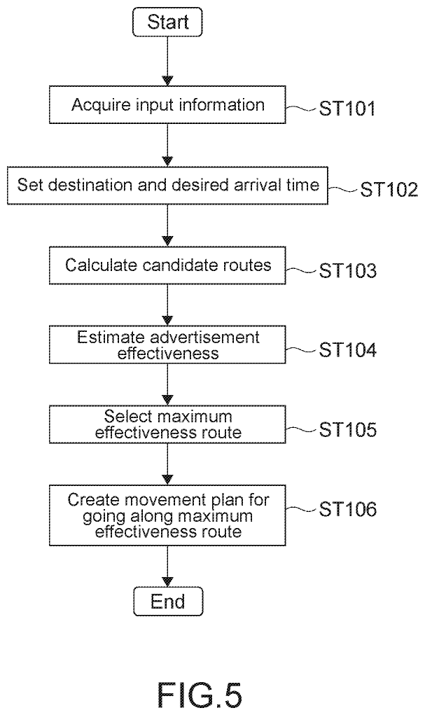

FIG. 5 is a flowchart illustrating an example of creating a movement plan.

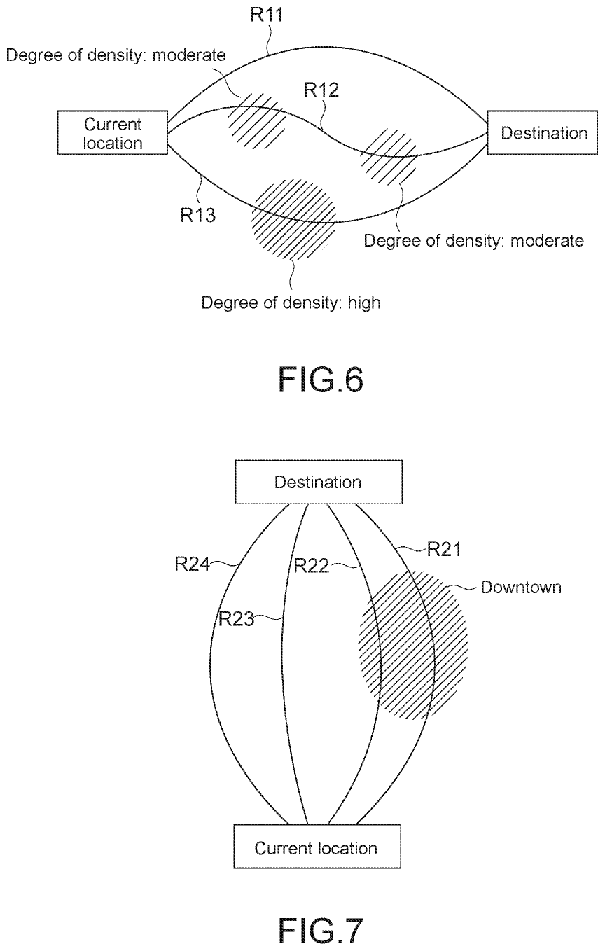

FIGS. 6 to 8 are schematic diagrams each used to describe the example of creating a movement plan.

Input information that is input through the user terminal 1 is acquired by the input information acquiring section 26 (Step 101).

A destination of the advertisement vehicle 2 and a desired time of arrival at the destination that are included in the input information are output to the plan creation section 18 and set to be input parameters (Step 102).

Note that a current location of the advertisement vehicle 2 and a current time are also used as input parameters.

A plurality of candidate routes R to the destination is calculated by the candidate route calculator 30 on the basis of the input parameters (Step 103).

In the example illustrated in FIG. 6, three candidate routes R that are a candidate route R11, a candidate route R12, and a candidate route R13 are calculated.

Any route that makes it possible to arrive at a destination by a desired arrival time may be calculated as the candidate route R. For example, a shortest route or a route for which time is spent as much as possible is calculated as a candidate route. Moreover, any method may be used as a method for calculating a candidate route.

The advertisement effectiveness is estimated by the advertisement effectiveness estimator 31 for each candidate route R (Step 104). The advertisement effectiveness is estimated by using estimated viewer information, surrounding region information, and advertisement target information as appropriate.

In the example illustrated in FIG. 6, the number of pedestrians on each candidate route R and a degree of density at each location on the candidate route R are used. In other words, estimated viewer information is used to estimate advertisement effectiveness.

As illustrated in FIG. 6, there are few pedestrians on the candidate route R11. Thus, a degree of advertisement effectiveness is estimated to be low.

On the candidate route R12, there are two areas with a moderate degree of pedestrian density, and thus a degree of advertisement effectiveness is estimated to be highest.

On the candidate route R13, there is an area with a higher degree of pedestrian density, compared to the candidate routes R other than the candidate route R13. On the other hand, the number of such areas is one, and thus a degree of advertisement effectiveness is estimated to be second highest.

Note that how many people will be able to actually view the advertisement of the advertisement vehicle 2 may be predicted from the number of pedestrians and a degree of pedestrian density on the candidate route R. In other words, how many people will encounter the advertisement vehicle 2 may be predicted, and the advertisement effectiveness may be estimated on the basis of a result of the prediction.

A maximum effectiveness route that achieves a highest degree of advertisement effectiveness is selected by the plan creation section 18 from the three candidate routes R (Step 105). It can also be said that the maximum effectiveness route is a route on which the advertisement vehicle 2 arrives at a destination in time and is most seen by people.

In the example illustrated in FIG. 6, the candidate route

R12 is selected as the maximum effectiveness route.

A movement plan is created by the plan creation section 18 such that the advertisement vehicle 2 moves along the candidate route R12 corresponding to the maximum effectiveness route (Step 106).

For example, information regarding how to travel along the candidate route R12 may be created as a movement plan. Alternatively, only information regarding the candidate route R12 may be created as a movement plan.

In the example illustrated in FIG. 7, information regarding a degree of density that is included in estimated viewer information is used in Step 104. Specifically, the advertisement effectiveness for each candidate route R is estimated using information regarding a downtown in which a degree of density is high.

A candidate route R21 is a route for traveling a longest distance through a downtown, and is estimated to achieve a highest degree of advertisement effectiveness.

A candidate route R22 is a route for traveling a second-longest distance through the downtown, and is estimated to achieve a second-highest degree of advertisement effectiveness.

Candidate routes R23 and R24 are routes that do not pass through the downtown, and are thus estimated to achieve a lowest degree of advertisement effectiveness.

In Step 105, the candidate route R21 is selected as the maximum effectiveness route.

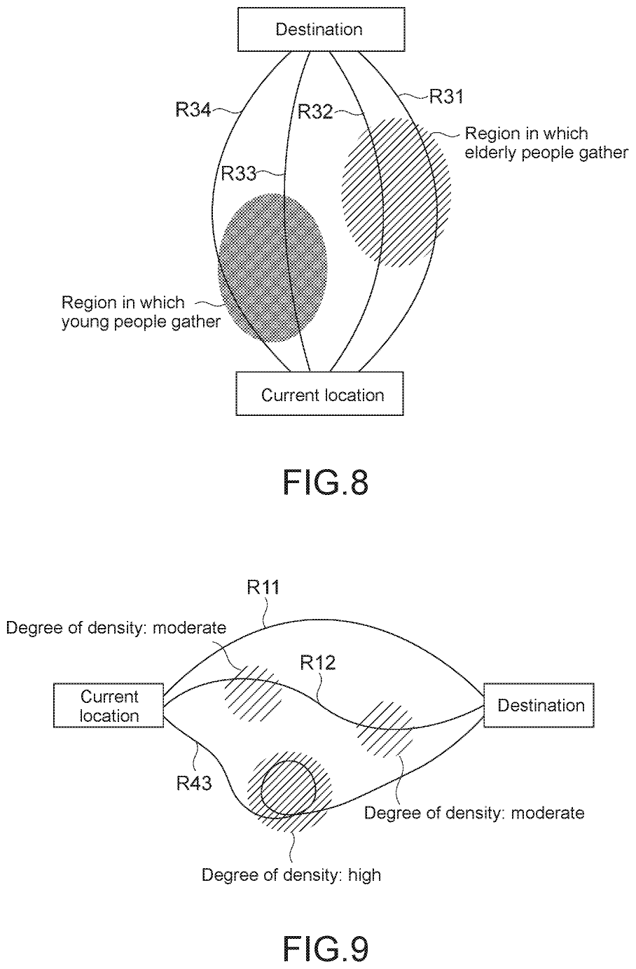

In the example illustrated in FIG. 8, estimated viewer information and advertisement target information are used in Step 104.

First, the fact that young people are advertisement targets is acquired by the advertisement management section 22 as the advertisement target information. Then, the number of pedestrians and a degree of pedestrian density are acquired on a generation basis for each candidate route R. These pieces of information are pieces of information included in the estimated viewer information.

Candidate routes R31 and R32 pass through a region in which elderly people gather, and thus it is determined that the candidate routes R31 and R32 each achieve a low degree of advertisement effectiveness.

Candidate routes R33 and R34 pass through a region in which young people gather, and thus it is determined that the candidate routes R33 and R34 each achieve a high degree of advertisement effectiveness. In particular, the candidate route R33 is a route for moving a long distance through the center of the region in which young people gather, and is thus estimated to achieve a highest degree of advertisement effectiveness.

In Step 105, the candidate route R33 is selected as the maximum effectiveness route.

The above-described application of the present technology makes it possible to achieve a high degree of advertisement effectiveness for an advertisement target.

FIG. 9 schematically illustrates another example of calculating a maximum effectiveness route.

In the example illustrated in FIG. 6, the candidate route R is calculated such that movement to a destination is given priority.

On the other hand, when there is a sufficient time before a desired arrival time, a maximum effectiveness route including, for example, stopping on the way, parking at a specified location, going a long way, or going around one area may be calculated.

For example, the candidate route R13 illustrated in FIG. 6 is updated to a candidate route R43 that is a route of going around an area with a highest degree of density. The candidate route R43 obtained by the update is selected as the maximum effectiveness route.

As described above, the candidate route R may be updated to increase advertisement effectiveness. This results in achieving a higher degree of advertisement effectiveness.

Of course, a route including, for example, stopping on the way, parking at a specified location, going a long way, or going around one area may be calculated as the candidate route R at the beginning. In this case, it can also be said that the route is the candidate route R calculated when advertisement effectiveness is given priority.

Further, a movement plan in which parking (stopping) is performed in an area with a highest degree of density as long as time allows, may be created.

Variations of creating a movement plan that achieves a high degree of advertisement effectiveness are described together below. Without being limited to the example in which a candidate route is calculated to estimate advertisement effectiveness, as illustrated in FIG. 5, various variations are conceivable.

For example, a movement plan may be directly created on the basis of, for example, estimated viewer information, surrounding environment information, or advertisement target information. In other words, a movement plan including a large number of parameters corresponding to factors in increasing advertisement effectiveness may be created without estimating advertisement effectiveness.

For example, a movement plan for moving along, for example, a route on which a large number of pedestrians ranges, or a route that passes through a downtown may be directly created. Of course, a route of going around, for example, a downtown may be calculated. Further, a movement plan including parking in a downtown may be created.

On the other hand, a plurality of candidate routes may be created in Step 103 illustrated in FIG. 5 on the basis of a parameter that is a factor in increasing advertisement effectiveness. Then, the advertisement effectiveness may be estimated to select a maximum effectiveness route.

With respect to the calculation of a route to a destination using, for example, estimated viewer information, the route may be calculated as a final movement plan, or may be calculated as a candidate route in Step 103.

A route with traffic jam or a route on which traffic jam easily occurs is calculated on the basis of traffic volume. There is a reduction in movement speed due to traffic jam. Thus, advertisement content is more likely to be viewed by, for example, a pedestrian in the area. Further, advertisement content is also more likely to be viewed by a person in another vehicle in traffic jam. Consequently, a high degree of advertisement effectiveness is achieved.

A movement plan is created such that the advertisement vehicle 2 travels on a route with heavy pedestrian traffic in fine weather. Advertisement content is more likely to be viewed in fine weather than in the rain. Consequently, a high degree of advertisement effectiveness is achieved.

A movement plan is created such that the advertisement vehicle 2 travels in time to a lunch break or going home. Consequently, the number of viewers of advertisement content is more likely to increase. This results in achieving a high degree of advertisement effectiveness.

A traveling plan may be created that enables traveling during a lunch break in an area with a large number of restaurants or traveling in an area near, for example, a train station in a period of time for going home.

A movement plan is created such that the advertisement vehicle 2 travels focused on an area in which there is a person who stays long. The person staying longer, that is, a person who is in one place for a longer time is more likely to take his/her time to view advertisement content. This results in achieving a high degree of advertisement effectiveness.

A movement plan is created such that a movement speed is made as low as possible. For example, a movement plan is created such that the advertisement vehicle 2 intentionally travels slowly. This results in achieving a high degree of advertisement effectiveness.

A movement plan is created such that the advertisement vehicle 2 travels in a lane near a sidewalk. Consequently, advertisement content becomes noticeable to a pedestrian. This results in achieving a high degree of advertisement effectiveness.

### Examples of Creation with Time Constraints

(1) A plurality of routes is calculated from four kinds of input including a current location, a current time, a destination, and a desired arrival time.
(2) Information regarding the number of people on a route (estimated viewer information) is acquired.
(3) A route on which a largest number of people ranges is selected from routes that make it possible to arrive at a destination in time.

### Examples of Creation with Less Strict Time Constraints

(1) A plurality of routes is calculated from four kinds of input including a current location, a current time, a destination, and a desired arrival time.
(2) Information regarding a dense region, on a route, that exhibits a highest degree of density of people (estimated viewer information) is acquired.
(3) A traveling plan for going around the dense region, or a traveling plan for parking or stopping in the dense region is created.

### Examples of Creation when Target Advertisement is Performed: Advertisement Content is Determined First

(1) A target group for advertisement content is determined from advertisement target information.
(2) An area in which there is a large number of people belonging to the target group for the advertisement content is calculated from estimated viewer information.
(3) A traveling plan is designed such that the advertisement vehicle 2 can stay in the area long.

A movement plan may be created on the basis of advertisement target information, as described above.

### Examples of Creation when Target Advertisement is Performed: Distribution of Estimated Viewers is Determined First

(1) Distribution information regarding a distribution of estimated viewers is acquired.
(2) An attribute (for example, men in their twenties) of a largest number of distributed estimated viewers is determined.
(3) Advertisement content that can most strongly appeal to the attribute (advertisement content of which a target is closest to the attribute) is selected, and a traveling plan is created such that the advertisement vehicle 2 can stay in an area with a large number of estimated viewers belonging to the attribute.

The distribution information regarding a distribution of estimated viewers, and the attribute of estimated viewers are pieces of information included in estimated viewer information. Advertisement content may be selected on the basis of estimated viewer information, as described above. The application of the present technology makes it possible to create a movement plan that increases advertisement effectiveness provided by selected advertisement content.

As described above, in the information processing apparatus 3 according to the present embodiment, a movement plan of the advertisement vehicle 2 is created in association with advertisement effectiveness on the basis of a destination and a desired arrival time.

This makes it possible to create the movement plan enabling the advertisement vehicle 2 to arrive at a destination by a desired arrival time, and achieving a highest degree of advertisement effectiveness. This results in being able to achieve a high degree of advertisement effectiveness in advertisement using a mobile object.

A system that provides a route for arriving at a destination early is conceivable as a system used to search for a route to a destination. If the advertisement vehicle 2 or the like being capable of playing back advertisement content outward is caused to travel using such a system, it will be difficult to achieve a sufficiently high degree of advertisement effectiveness.

The application of the present technology makes it possible to move in time and achieve a high degree of advertisement effectiveness at the same time.

When the advertisement vehicle 2 includes an automated driving function, as in the case of the present embodiment, a user can spend time freely during traveling. For example, the user can work or enjoy content in the boarding space S until arrival at a destination.

For example, the application of the present technology makes it possible to cause a user to use his/her traveling time efficiently and to achieve a high degree of advertisement effectiveness. For example, a user leaves early, and this enables the user to work intensively to finish work before arrival at a destination or to see a movie from start to finish. In addition, the user has time to spare until a desired arrival time. This enables the user to travel to a destination on the basis of a movement plan that achieves a very high degree of advertisement effectiveness.

Of course, it is sufficient if the user arrives at a destination before a desired arrival time. Thus, it is not a problem if the route includes, for example, going a long way, going around, or a stopping for a long period of rime.

For example, when the advertisement vehicle 2 is, for example, a company's vehicle, this makes it possible to advertise a product of the company with a high degree of advertisement effectiveness.

Further, when a system in which an advertising income is received from an advertiser depending on advertisement effectiveness is adopted, the advertising income can be increased since a high degree of advertisement effectiveness can be achieved.

Of course, the present technology is not limited to being applied to such a system.

### Second Embodiment

A second embodiment of the information processing apparatus 3 illustrated in FIG. 1 is described in detail.

The description is made below focused on a point different from that of the embodiment described above, and descriptions of a configuration and an operation similar to those of the information processing apparatus 3 described in the embodiment above are omitted or simplified.

In the present embodiment, the advertisement vehicle 2 is used as a vehicle that can provide transportation services.

In the present embodiment, the advertisement vehicle 2 is used as a taxi that transports people to a destination. Of course without being limited thereto, the present technology can also be applied to the case in which a transportation target is, for example, an animal other than a human being, or goods.

For example, a user dispatches the advertisement vehicle 2 (a taxi) using the user terminal 1 illustrated in FIG. 1. At this point, a destination and a desired arrival time are input. Of course, the user hails to get into the advertisement vehicle 2 (a taxi) on a street, and operates the user terminal 1 or the operation section 11 of the advertisement vehicle 2 to input the destination and the desired arrival time.

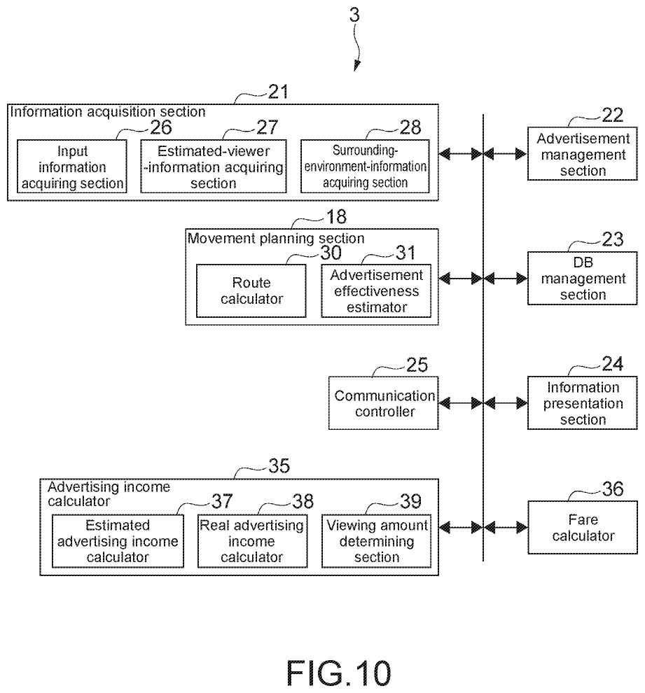

FIG. 10 is a block diagram illustrating an example of the functional configuration of the information processing apparatus 3 according to the present embodiment. The advertisement vehicle 2 according to the present embodiment further includes an advertising income calculator 35 and a fare calculator 36.

The advertising income calculator 35 can calculate an advertising income depending on advertisement effectiveness provided by advertisement content played back outward from the advertisement vehicle 2. Note that the advertising income itself may be used as a parameter used to determine advertisement effectiveness.

In the present embodiment, the advertising income calculator 35 includes an estimated advertising income calculator 37, a real advertising income calculator 38, and a viewing amount determining section 39, as illustrated in FIG. 10.

The estimated advertising income calculator 37 calculates an estimated advertising income depending on estimated advertisement effectiveness.

The real advertising income calculator 38 calculates a real advertising income on the basis of an amount of viewing of advertisement content.

The viewing amount determining section 39 determines an amount of viewing of advertisement content.

Any methods may be adopted as a method for calculating an estimated advertising income on the basis of estimated advertisement effectiveness and a method for calculating a real advertising income on the basis of a viewing amount. For example, a user and, for example, an advertiser who pays advertising rates that correspond to an advertising income for the user may set as appropriate an expression or an algorithm used to calculate an estimated advertising income and a real advertising income. A machine learning algorithm may be used.

For example, expressions listed below may be used.

Estimated advertising income=estimated advertisement effectiveness×playback time of advertisement

Estimated advertising income=estimated advertisement effectiveness×playback time of advertisement×weighting coefficient

Real advertising income=viewing amount×playback time of advertisement

Real advertising income=viewing amount×playback time of advertisement×weighting coefficient

For example, the weighting coefficient is a parameter that is calculated according to b advertisement content.

The fare calculator 36 calculates a fare that is a compensation for transportation services.

In the present embodiment, an estimated fare for the candidate route R, and a real fare for an actual movement route can be calculated.

Any methods may be adopted as methods for calculating an estimated fare and a real fare. For example, an estimated fare and a real fare are calculated on the basis of, for example, a distance of a route and a weight of a transportation target. Of course, the calculation methods are not limited thereto.

### Example of Operation of Transportation Services

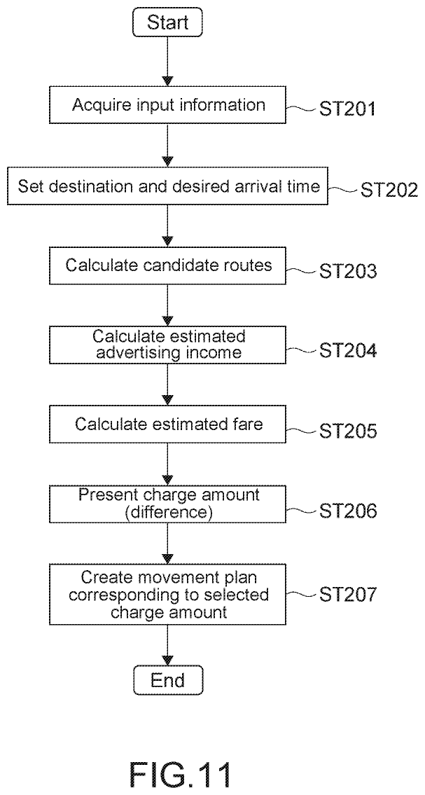

FIG. 11 is a flowchart illustrating an example of operating transportation services according to the present embodiment.

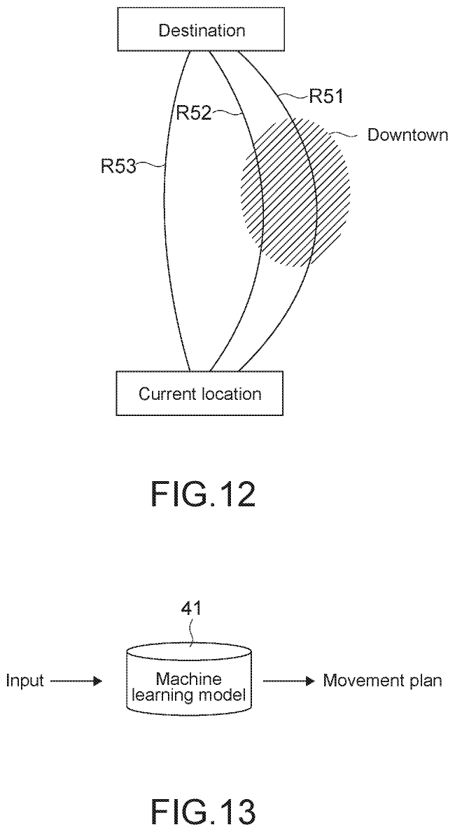

FIG. 12 is a schematic diagram used to describe the example of operating the transportation services.

Steps 201 to 203 illustrated in FIG. 11 are similar to Steps 101 to 103 illustrated in FIG. 5.

The estimated advertising income calculator 37 calculates estimated advertising incomes for respective candidate routes R of a plurality of candidate routes R (Step 204).

The fare calculator 36 calculates estimated fares for the respective candidate routes R of the plurality of candidate routes R (Step 205).

The information presentation section 24 presents a difference between an estimated advertising income and the estimated fare for each candidate route R to a user as a charge amount. For example, a GUI or the like including a charge amount (a difference) is generated to be transmitted to the user terminal 1 or the operation section 11 of the advertisement vehicle 2 (Step 206).

For example, information indicated below is presented to a user.
(Candidate route R51) fare: JPY1500, advertising income: JPY600, charge amount: JPY900
(Candidate route R52) fare: JPY1000, advertising income: JPY300, charge amount: JPY700
(Candidate route R53) fare: JPY900, advertising income: JPY100, charge amount: JPY800

In the present embodiment, a user can perform selection from the presented candidate routes R. For example, a user selects the candidate route R with a smallest charge amount. Of course, any other candidate route R may be selected.

Note that the information presentation section 24 may only present, to a user, a minimum charge amount route with a smallest charge amount. Further, a user may be able to perform selection to determine whether the minimum charge amount route is to be acceptable. When a user inputs an instruction to display another route, information regarding the other candidate route R is presented with at least a charge amount. Of course, a fare and an advertising income may also be presented together.

Moreover, any method may be adopted as the method for presenting a charge amount (a difference) to a user.

The plan creation section 18 creates a movement plan that corresponds to a charge amount selected by the user. Specifically, a movement plan is created such that the advertisement vehicle 2 moves on the candidate route R corresponding to the charge amount selected by the user (Step 207).

As described above, in the present embodiment, an estimated advertising income and an estimated fare are calculated, and a difference between them is presented to a user as a charge amount. This makes it possible to provide transportation services advantageous to both a user and an advertiser.

Of course, a user may be able to input an instruction to travel on a shortest route even with a large charge amount.

Alternatively, a user may be able to input an instruction to keep a charge amount low even if the route includes going a long way.

Moreover, a flexible system operation advantageous to both a user and an advertiser can be provided.

The viewing amount determining section 39 determines an amount of viewing of advertisement content by, for example, analyzing an image of a region around the advertisement vehicle 2 that is captured using the image-capturing section 8 and by performing object recognition.

For example, the number of people viewing advertisement content, a gender of a person viewing the advertisement content, a degree of attention paid by a person viewing the advertisement content, and the like can be determined using, for example, a well-known object recognition technology or image analysis technology. An amount of viewing the advertisement content can be calculated as a parameter on the basis of a result of the determinations.

Of course, a machine learning algorithm may be used to determine and calculate a viewing amount.

A real advertising income calculated by the real advertising income calculator 38 is stored in the database 19 as, for example, performance history information. Further, for example, the real advertising income is used to calculate an estimated advertising income.

Further, the real advertising income may be used as a performance report to an advertiser. Furthermore, the real advertising income may be used when advertising rates are charged to an advertiser.

Of course, advertising rates may be charged to an advertiser only using an estimated advertising income without using a real advertising income.

Moreover, how to use data of a real advertising income is not limited, and may be set discretionarily.

### OTHER EMBODIMENTS

The present technology is not limited to the embodiments described above, and can achieve various other embodiments.

For example, a movement plan with a high degree of advertisement effectiveness may be created using a machine learning model 41, as illustrated in FIG. 13.

Input data is, for example, a current location, a current time, a destination, and a desired arrival time.

The machine learning model 41 is trained using training data.

The training data is data in which data for learning and a training label are associated with each other. For example, data that is similar to the input data (a current location, a current time, a destination, and a desired arrival time) is used as the data for learning. A movement plan with a high degree of advertisement effectiveness is used as the training label.

For example, a parameter (a coefficient) used to calculate an answer (a movement plan with a high degree of advertisement effectiveness) is updated by a learning section performing learning, and a parameter on which learning has been performed is generated. A program into which the generated parameter on which learning has been performed is incorporated, is generated as the machine learning model 41.

For example, backpropagation generally commonly used to train a neural network can be used as a learning method performed by the learning section. The neural network is a model obtained by mimicking a human brain neural network, and is a model having a layer structure that includes three types of layers that are an input layer, an intermediate layer (a hidden layer), and an output layer.

In particular, the neural network including a large number of intermediate layers is called a deep neural network. The deep neural network is known as a model in which deep learning used to train the deep neural network makes it possible to learn a complex pattern hidden in large volumes of data. Backpropagation is an example of such a learning method, and is commonly used to train, for example, a convolutional neural network (CNN) used to recognize an image or a moving image.

Further, a neurochip or a neuromorphic chip into which a concept of a neural network has been incorporated can be used as a hardware structure used to perform such machine learning.

Any other machine-learning algorithm may be used.

The creating a movement plan in association with advertisement effectiveness also includes creating a movement plan, such as a movement plan with a high degree of advertisement effectiveness, using a machine learning model constructed by a movement plan associated with advertisement effectiveness being used as a training label.

Note that, as described above, a machine learning algorithm can be applied to any other processing in the present disclosure.

The example of the advertisement vehicle 2 including an automated driving function and having no operator has been described above. Without being limited thereto, the present technology can also be applied to the advertisement vehicle 2 operated by a human.

For example, a route to a destination is created as a movement plan associated with advertisement effectiveness. The created route may be presented to a driver (such as a user or a driver of a taxi) as navigation information.

In other words, the present technology can also be applied to a navigation system of the advertisement vehicle 2.

With respect to a method for playing back advertisement content, a playback method that achieves a higher degree of advertisement effectiveness may be performed. For example, information (such as weather forecast) that interests a large number of people is displayed, and attracts attention from people. Then, advertisement content is played back. This results in achieving a higher degree of advertisement effectiveness. Any other playback method may be adopted.

All of or a portion of the functions of the information processing apparatus 3 may be included in the advertisement vehicle 2 illustrated in FIG. 1. In other words, all of or a portion of the functions of the information processing apparatus according to the present technology may be included in a mobile object that can play back advertisement content. In this case, the mobile object that can play back advertisement content serves as an embodiment of the information processing apparatus according to the present technology.

In the present disclosure, the vehicle is not limited to an automobile, and examples of the vehicle also include a bicycle and a two-wheeled vehicle (a motorcycle).

Further, the mobile object is not limited to a vehicle, and the present technology can also be applied to various mobile objects such as personal mobility, airplane, drone, ship, robot, construction machinery, and agricultural machinery (tractor).

FIG. 14 is a block diagram illustrating an example of a configuration of hardware of the information processing apparatus 3.

The information processing apparatus 3 includes a CPU 61, a ROM 62, a RAM 63, an input/output interface 65, and a bus 64 through which these components are connected to each other. A display section 66, an input section 67, a storage 68, a communication section 69, a drive 70, and the like are connected to the input/output interface 65.

The display section 66 is a display device using, for example, liquid crystal or EL. Examples of the input section 67 include a keyboard, a pointing device, a touch panel, and other operation apparatuses. When the input section 67 includes a touch panel, the touch panel may be integrated with the display section 66.

The storage 68 is a nonvolatile storage device, and examples of the storage 68 include an HDD, a flash memory, and other solid-state memories. The drive 70 is a device that can drive a removable recording medium 71 such as an optical recording medium or a magnetic recording tape.

The communication section 69 is a modem, a router, or another communication apparatus that can be connected to, for example, a LAN or a WAN and is used to communicate with another device. The communication section 69 may perform communication wirelessly or by wire. The communication section 69 is often used in a state of being separate from the information processing apparatus 3.

Information processing performed by the information processing apparatus 3 having the configuration of hardware described above is performed by software stored in, for example, the storage 68 or the ROM 62, and hardware resources of the information processing apparatus 3 working cooperatively. Specifically, the information processing method according to the present technology is performed by loading, into the RAM 63, a program included in the software and stored in the ROM 62 or the like and executing the program.

For example, the program is installed on the information processing apparatus 3 through the recording medium 61. Alternatively, the program may be installed on the information processing apparatus 3 through, for example, a global network. Moreover, any non-transitory computer-readable storage medium may be used.

The information processing method and the program according to the present technology may be executed and the information processing apparatus according to the present technology may be implemented by a plurality of computers communicatively connected to each other working cooperatively through, for example, a network.

In other words, the information processing method and the program according to the present technology can be executed not only in a computer system that includes a single computer, but also in a computer system in which a plurality of computers operates cooperatively.

Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

The execution of the information processing method and the program according to the present technology by the computer system includes, for example, both the case in which the creation of a movement plan, the estimation of advertisement effectiveness, the calculation of a candidate route, and the like are executed by a single computer; and the case in which the respective processes are executed by different computers. Further, the execution of the respective processes by a specified computer includes causing another computer to execute a portion of or all of the processes and acquiring a result of it.

In other words, the information processing method and the program according to the present technology are also applicable to a configuration of cloud computing in which a single function is shared and cooperatively processed by a plurality of apparatuses through a network.

The respective configurations of the user terminal, the advertisement vehicle, the information processing apparatus, and the like; the respective processing flows; and the like described with reference to the respective figures are merely embodiments, and any modifications may be made thereto without departing from the spirit of the present technology. In other words, for example, any other configurations or algorithms for purpose of practicing the present technology may be adopted.

When wording such as “substantially” or “about” is used in the present disclosure, such wording is merely used to facilitate the understanding of the description, and whether the wording such as “substantially” or “about” is used has no particular significance.

In other words, in the present disclosure, expressions, such as “center”, “middle”, “uniform”, “equal”, “similar”, “orthogonal”, “parallel”, “symmetric”, “extend”, “axial direction”, “columnar”, “cylindrical”, “ring-shaped”, and “annular” that define, for example, a shape, a size, a positional relationship, and a state respectively include, in concept, expressions such as “substantially the center/substantial center”, “substantially the middle/substantially middle”, “substantially uniform”, “substantially equal”, “substantially similar”, “substantially orthogonal”, “substantially parallel”, “substantially symmetric”, “substantially extend”, “substantially axial direction”, “substantially columnar”, “substantially cylindrical”, “substantially ring-shaped”, and “substantially annular”.

For example, the expressions such as “center”, “middle”, “uniform”, “equal”, “similar”, “orthogonal”, “parallel”, “symmetric”, “extend”, “axial direction”, “columnar”, “cylindrical”, “ring-shaped”, and “annular” also respectively include states within specified ranges (such as a range of +/−10%), with expressions such as “exactly the center/exact center”, “exactly the middle/exactly middle”, “exactly uniform”, “exactly equal”, “exactly similar”, “completely orthogonal”, “completely parallel”, “completely symmetric”, “completely extend”, “fully axial direction”, “perfectly columnar”, “perfectly cylindrical”, “perfectly ring-shaped”, and “perfectly annular” being respectively used as references.

Thus, an expression that does not include the wording such as “substantially” or “about” can also include, in concept, an expression including the wording such as “substantially” or “about”. Conversely, a state expressed using the expression including the wording such as “substantially” or “about” may include a state of “exactly/exact”, “completely”, “fully”, or “perfectly”.

In the present disclosure, an expression using “-er than” such as “being larger than A” and “being smaller than A” comprehensively includes, in concept, an expression that includes “being equal to A” and an expression that does not include “being equal to A”. For example, “being larger than A” is not limited to the expression that does not include “being equal to A”, and also includes “being equal to or greater than A”. Further, “being smaller than A” is not limited to “being less than A”, and also includes “being equal to or less than A”.

When the present technology is carried out, it is sufficient if a specific setting or the like may be adopted as appropriate from expressions included in “being larger than A” and expressions included in “being smaller than A”, in order to provide the effects described above.

At least two of the features of the present technology described above can also be combined. In other words, the various features described in the respective embodiments may be combined discretionarily regardless of the embodiments. Further, the various effects described above are not limitative but are merely illustrative, and other effects may be provided.

Note that the present technology may also take the following configurations.

(1) An information processing apparatus, including

a plan creation section that creates a plan of movement of a mobile object to a destination of the mobile object in association with advertisement effectiveness on the basis of the destination and a desired time of arrival at the destination, the advertisement effectiveness being provided by advertisement content played back outward from the mobile object.

(2) The information processing apparatus according to (1), in which

the plan creation section creates the movement plan enabling the mobile object to arrive at the destination by the desired arrival time, and achieving a highest degree of the advertisement effectiveness.

(3) The information processing apparatus according to (1) or (2), in which

the plan creation section
calculates a plurality of candidate routes to the destination,
estimates the advertisement effectiveness for each of the plurality of candidate routes, and
creates the movement plan on the basis of the estimated advertisement effectiveness.
   (4) The information processing apparatus according to (3), in which

the plan creation section creates the movement plan such that the mobile object moves along a maximum effectiveness route, from among the plurality of candidate routes, that achieves a highest degree of the advertisement effectiveness.

(5) The information processing apparatus according to (3) or (4), further including

an information acquisition section that is capable of acquiring estimated viewer information regarding an estimated viewer estimated to view the advertisement content, in which

the plan creation section estimates the advertisement effectiveness on the basis of the acquired estimated viewer information.

(6) The information processing apparatus according to (5), in which

the estimated viewer information includes at least one of the number of the estimated viewers, an age of the estimated viewer, a gender of the estimated viewer, or a stay time of the estimated viewer.

(7) The information processing apparatus according to (5) or (6), in which

the estimated viewer information includes at least one of pedestrian information regarding a pedestrian or information regarding a degree of density of people.

(8) The information processing apparatus according to any one of (5) to (7), in which

the mobile object is a vehicle,

the information acquisition section is capable of acquiring surrounding environment information that includes at least one of traffic volume, traffic laws, weather, or a period of time, and

the plan creation section estimates the advertisement effectiveness on the basis of the acquired surrounding environment information.

(9) The information processing apparatus according to any one of (1) to (8), in which

the movement plan includes at least one of a route to the destination, a movement speed, a stop location, or a stop period of time at the stop location.

(10) The information processing apparatus according to (9), in which

the mobile object is a vehicle, and

the movement plan includes at least one of a route to the destination, a traveling lane, a traveling speed, a parking location, or a parking period of time at the parking location.

(11) The information processing apparatus according to any one of (1) to (10), further including

an information acquisition section that is capable of acquiring estimated viewer information regarding an estimated viewer estimated to view the advertisement content, in which

the plan creation section creates the movement plan on the basis of the acquired estimated viewer information.

(12) The information processing apparatus according to any one of (1) to (11), further including

an advertisement-target-information acquiring section that acquires advertisement target information regarding a target for an advertisement of the advertisement content, in which

the plan creation section creates the movement plan on the basis of the acquired advertisement target information.

(13) The information processing apparatus according to any one of (1) to (12), further including

an information acquisition section that is capable of acquiring estimated viewer information regarding an estimated viewer estimated to view the advertisement content; and

an advertisement content selecting section that selects the advertisement content on the basis of the acquired estimated viewer information.

(14) The information processing apparatus according to (1), in which

the mobile object provides transportation services, the plan creation section calculates a plurality of candidate routes to the destination, and

the information processing apparatus further includes an advertising income calculator that calculates an estimated advertising income for each of the plurality of candidate routes.

(15) The information processing apparatus according to (14), further including:

a fare calculator that calculates an estimated fare for each of the plurality of candidate routes; and

a presentation section that presents a difference between the estimated advertising income and the estimated fare.

(16) The information processing apparatus according to (15), in which

the advertising income calculator is capable of calculating a real advertising income on the basis of an amount of viewing of the advertisement content.

(17) An information processing method that is performed by a computer system, the information processing method including

creating a plan of movement of a mobile object to a destination of the mobile object in association with advertisement effectiveness on the basis of the destination and a desired time of arrival at the destination, the advertisement effectiveness being provided by advertisement content played back outward from the mobile object.

(18) A program that causes a computer program to perform a process including

creating a plan of movement of a mobile object to a destination of the mobile object in association with advertisement effectiveness on the basis of the destination and a desired time of arrival at the destination, the advertisement effectiveness being provided by advertisement content played back outward from the mobile object.

### REFERENCE SIGNS LIST

R11 to R13, R21 to R24, R31 to R34, R43, R51 to R53 candidate route
1 user terminal
2 advertisement vehicle
3 information processing apparatus
8 image-capturing section
10 advertisement display section
21 information acquisition section
22 advertisement management section
24 information presentation section
26 input information acquiring section
27 estimated-viewer-information acquiring section
28 surrounding-environment-information acquiring section
30 candidate route calculator
31 advertisement effectiveness estimator
35 advertising income calculator
37 estimated advertising income calculator
38 real advertising income calculator
39 viewing amount determining section
100 movement plan creating system

1. An information processing apparatus, comprising
a plan creation section that creates a plan of movement of a mobile object to a destination of the mobile object in association with advertisement effectiveness on a basis of the destination and a desired time of arrival at the destination, the advertisement effectiveness being provided by advertisement content played back outward from the mobile object.

2. The information processing apparatus according to claim 1, wherein
the plan creation section creates the movement plan enabling the mobile object to arrive at the destination by the desired arrival time, and achieving a highest degree of the advertisement effectiveness.

3. The information processing apparatus according to claim 1, wherein
the plan creation section
calculates a plurality of candidate routes to the destination,
estimates the advertisement effectiveness for each of the plurality of candidate routes, and
creates the movement plan on a basis of the estimated advertisement effectiveness.

4. The information processing apparatus according to claim 3, wherein
the plan creation section creates the movement plan such that the mobile object moves along a maximum effectiveness route, from among the plurality of candidate routes, that achieves a highest degree of the advertisement effectiveness.

5. The information processing apparatus according to claim 3, further comprising
an information acquisition section that is capable of acquiring estimated viewer information regarding an estimated viewer estimated to view the advertisement content, wherein
the plan creation section estimates the advertisement effectiveness on a basis of the acquired estimated viewer information.

6. The information processing apparatus according to claim 5, wherein
the estimated viewer information includes at least one of the number of the estimated viewers, an age of the estimated viewer, a gender of the estimated viewer, or a stay time of the estimated viewer.

7. The information processing apparatus according to claim 5, wherein
the estimated viewer information includes at least one of pedestrian information regarding a pedestrian or information regarding a degree of density of people.

8. The information processing apparatus according to claim 5, wherein
the mobile object is a vehicle,
the information acquisition section is capable of acquiring surrounding environment information that includes at least one of traffic volume, traffic laws, weather, or a period of time, and
the plan creation section estimates the advertisement effectiveness on a basis of the acquired surrounding environment information.

9. The information processing apparatus according to claim 1, wherein
the movement plan includes at least one of a route to the destination, a movement speed, a stop location, or a stop period of time at the stop location.

10. The information processing apparatus according to claim 9, wherein
the mobile object is a vehicle, and
the movement plan includes at least one of a route to the destination, a traveling lane, a traveling speed, a parking location, or a parking period of time at the parking location.

11. The information processing apparatus according to claim 1, further comprising
an information acquisition section that is capable of acquiring estimated viewer information regarding an estimated viewer estimated to view the advertisement content, wherein
the plan creation section creates the movement plan on a basis of the acquired estimated viewer information.

12. The information processing apparatus according to claim 1, further comprising
an advertisement-target-information acquiring section that acquires advertisement target information regarding a target for an advertisement of the advertisement content, wherein
the plan creation section creates the movement plan on a basis of the acquired advertisement target information.

13. The information processing apparatus according to claim 1, further comprising
an information acquisition section that is capable of acquiring estimated viewer information regarding an estimated viewer estimated to view the advertisement content; and
an advertisement content selecting section that selects the advertisement content on a basis of the acquired estimated viewer information.

14. The information processing apparatus according to claim 1, wherein
the mobile object provides transportation services,
the plan creation section calculates a plurality of candidate routes to the destination, and
the information processing apparatus further comprises an advertising income calculator that calculates an estimated advertising income for each of the plurality of candidate routes.

15. The information processing apparatus according to claim 14, further comprising:
a fare calculator that calculates an estimated fare for each of the plurality of candidate routes; and
a presentation section that presents a difference between the estimated advertising income and the estimated fare.

16. The information processing apparatus according to claim 15, wherein
the advertising income calculator is capable of calculating a real advertising income on a basis of an amount of viewing of the advertisement content.

17. An information processing method that is performed by a computer system, the information processing method comprising
creating a plan of movement of a mobile object to a destination of the mobile object in association with advertisement effectiveness on a basis of the destination and a desired time of arrival at the destination, the advertisement effectiveness being provided by advertisement content played back outward from the mobile object.

18. A program that causes a computer program to perform a process comprising
creating a plan of movement of a mobile object to a destination of the mobile object in association with advertisement effectiveness on a basis of the destination and a desired time of arrival at the destination, the advertisement effectiveness being provided by advertisement content played back outward from the mobile object.
